(19) United States
(12) Patent Application Publication
(10) Pub. No.: US 2012/0216457 A1
(43) Pub. Date: Aug. 30, 2012

(54) Gravity feed precision irrigation system

(76) Inventor: Robenn Robb, Kihei, HI (US)

(21) Appl. No.: 13/385,203

(22) Filed: Feb. 8, 2012

Related U.S. Application Data
(60) Provisional application No. 61/463,842, filed on Feb. 24, 2011.

(51) Int. Cl. A01G 29/00

(52) U.S. Cl. 47/48.5

(57) ABSTRACT

A gravity feed subterranean system for watering plants at their roots, comprising a vertically disposed reservoir buried at least partially in the ground, a water input line having positive water pressure connected to a float valve constructed and arranged within said reservoir such that when the liquid in the reservoir reaches a desired level, the float valve stops water flow from the input line, a buried output line connected to the reservoir below ground level on one end and plugged at the other, such that the water in the reservoir gravity pressurizes and fills the output line, and at least one hole through the output line.

### CROSS REFERENCES TO RELATED APPLICATIONS

None

### STATEMENT REGARDING FEDERALLY SPONSORED RESEARCH OR DEVELOPMENT

This invention is not the product of any Federally Sponsored Research or Development.

### REFERENCE TO MICROFICHE APPENDIX

Not Applicable

### TECHNICAL FIELD

Soil based gravity feed precision irrigation system

### BACKGROUND OF CURRENT INVENTION

The environmentally conscience managers of fertilizers and controllers of the nutrient solutions as applied to soils for growing plants have demanded more and more precision in the application of water, fertilizer, and other nutrients. Besides the expense of these necessary elements, seepage into the water table can adversely affect the immediate environment and the planet as a whole. Organic pest control has also become a priority, and most undesirable bugs that are destructive to crops all have a commonality: they need water, and are attracted to watered areas, such as cultivated fields. To grow the plants, the grower waters and adds fertilizers and nutrients to increase production, only to lose production to destructive bugs. The wide use of pesticides has caused a lot of damage to the environment, and lessons learned in the poisoning of the earth to kill some pests teach away from this self-destructive practice. Inventors have approached solutions to this problem by developing systems and devices that precisely apply the needed elements to grow plants without wasting the same in areas where plants are not to be grown, but each has their shortcomings. Some require complicated automated valves; others mandate the use of plant containers. There is a need for a simple and economical system that accurately delivers water and nutrients directly to the plant root system without using plant containers.

### ASPECTS AND SUMMARY OF INVENTION

It is an aspect of the present invention to provide a simple, easy-to-install subterranean irrigation system that uses gravity to maintain desired moisture levels in the soil.

It is also an aspect of the invention to present a system that precisely locates both water and nutrients at the root level of the plants.

Another aspect of the present invention is to provide over-watering protections in that the water level in the soil above each aperture physically restricts the introduction of additional fluid from the output line, as the gravity force at the reservoir is the same as the gravity force at the aperture. The aperture will only pass fluid if the pressure within the output line exceeds the soil restrictions outside. Since saturated soil acts as a wet seal on the aperture and dry soil acts as a sponge, the moisture content of the soil above and around the aperture acts as a natural watering control valve at each aperture, providing the plant what it needs to thrive.

Still further aspects according to the present invention, an adjustable float valve sets the fluid level in the reservoir, thereby allowing precision control of the pressures within the output line, thus controlling the moisture content around the aperture. The higher the fluid level within the reservoir, the greater the gravity pressure in the output line.

Further according to the present invention, nutrients such as soluble plant food can be dropped into the reservoir, dissolved and intermixed to be fed to the plants through the output line apertures. The dissolving and intermixing is enhanced through the fluid motion of water flowing into the reservoir, as allowed when the float valve drops below the desired set fluid level.

### BRIEF DESCRIPTION OF THE DRAWINGS

The described structure, operation, and advantages of the same will become apparent to one skilled in the art upon consideration of the following description as viewed in light of the accompanying illustrative figures. These figures are intended to be illustrative to assist in a full and complete understanding, and are not intended to be, in any way, limiting.

The illustrated elements in the figures are not-to-scale, for clarity. The cross-sectional views are approximates, and do not accurately represent that a contemporary cross-section may or may not be included.

FIG. 1 is a schematic cross sectional view of the present invention as installed in a single output line configuration.

FIG. 2 is a top down view of a schematic illustration of the present invention as having a plurality of output lines running from a single reservoir with apertures open in the direction of the surface.

FIG. 3 is a diagrammatic cross sectional view showing the float valve adjustability detail as setting desired fluid level within the reservoir.

FIG. 4 is a diagrammatic cross sectional view demonstrating the nutrient mixing with water within the reservoir.

FIG. 5 is a diagrammatic cross sectional view illustrating in drier soils, more water flows as opposed to wet or saturated soils, in which less water flows.

### DETAILED DESCRIPTION OF DRAWINGS

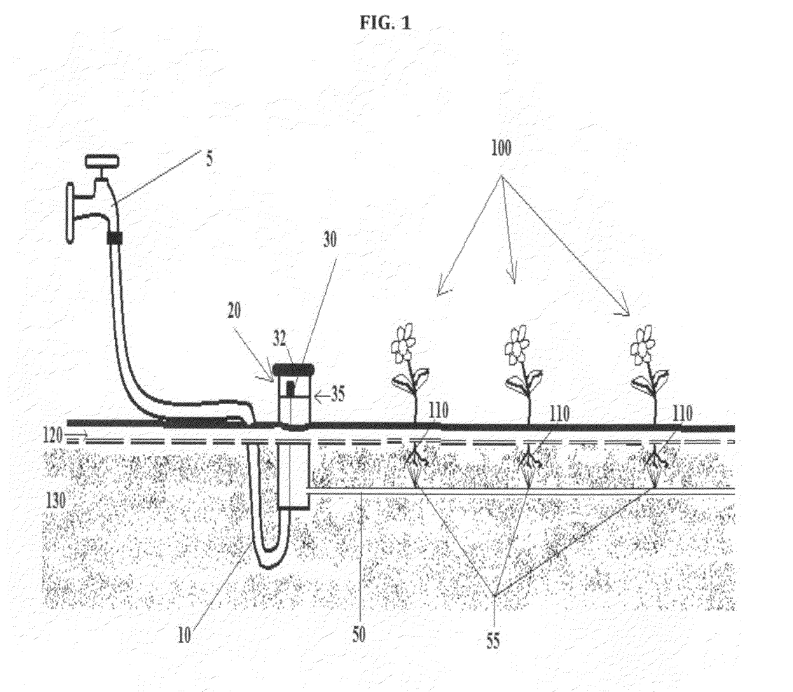

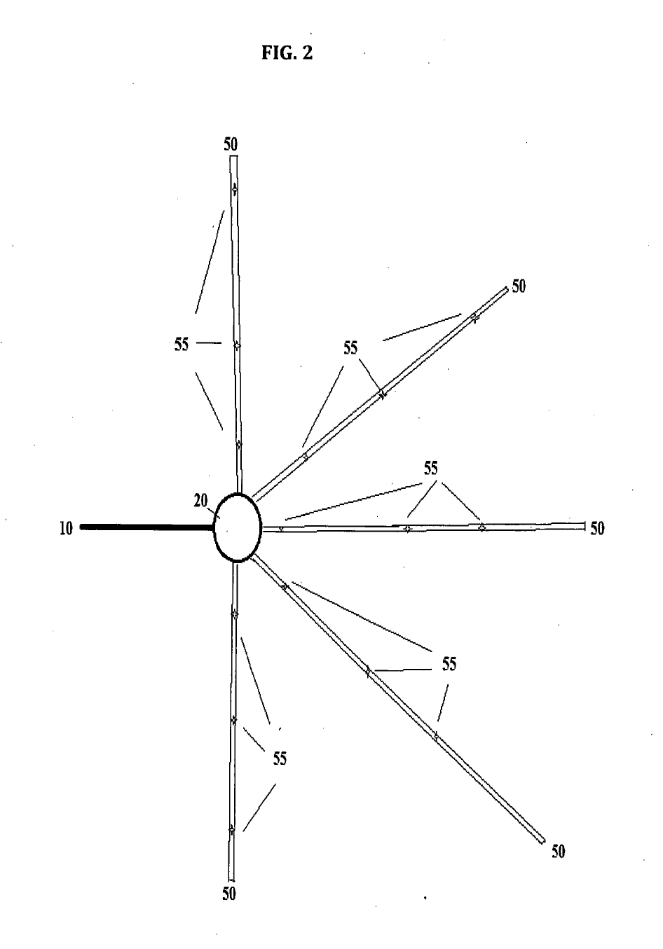

As depicted in FIG. 1, a watering and plant feeding system that provides subterranean irrigation of plants 100 in residential, commercial, or industrial application. The system comprises a water input line 10, a vertically disposed reservoir 20, a float valve 30, and an output line 50. The output line 50 may be a soaker hose or a regular hose line that has holes 55 formed at the location where the watering is desired. The embodiment shown is a single output line, however, in practice a plurality of output lines 50 could be implemented to water larger areas as shown in FIG. 2. The reservoir 20 includes a lid 32 and a float valve 30 with the output line 50 running out of the reservoir 20 below surface level 120.

The water input line 10 provides a constant pressure water source 5. This may be augmented with timers or other controller technologies, or simply manually operated by the user at the preferred embodiment as depicted as a ‘leave on’ the water source 5 system. The reservoir 20 needs to be of adequate height to be installed partially underground and partially above ground thereby allowing for access from above for the lid 32 to be removed when adding nutrients. The bottom of the reservoir 20 must be below the output line 50, and the top of the reservoir 20 needs to be at least surface level 120, but may be above surface level 120, depending on application.

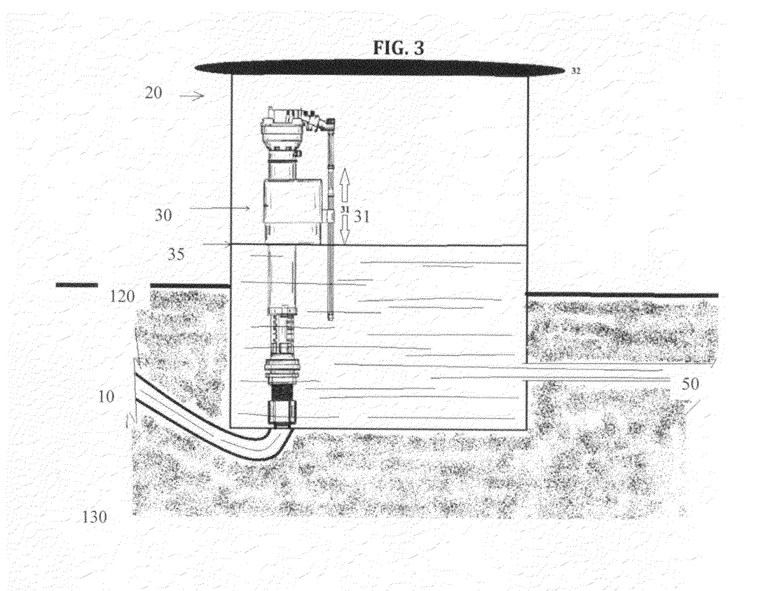

As shown in FIG. 3, the float valve 30 is located internal to the reservoir 20, and constructed and arranged to accurately maintain a fill level 35 of water from the input line 10 into the reservoir 20. The fill level 35 is adjustable, thereby allowing the user to set the “pressure” of outflow through the output line 50. The float valve 30, as used in the preferred embodiment, is a commercially-available toilet bowl float valve, but any type of similar functional float valve 30 will suffice.

The preferred embodiment as shown in FIGS. 1, 3, and 4, The output line 50 runs underneath the plants 100 that are planted in the soil 130, without containers. At each plant location, at least one hole 55 is formed through the output line 50, thereby allowing for a desired amount of water or nutrient solution to be introduced directly below the plant, where the roots 110 are located. The adjustable float valve 30 keeps the water level at an easily maintained and controlled level in the reservoir 20, and the grower monitors the needs of the plants verses the level of water or nutrient solution in the reservoir 20, thereby adjusting the float valve 30 to optimize plant health. Soil compaction, soil consistency, and the length of the output line 50 all dictate the optimum height of the reservoir 20 and the relative reservoir 20 fill level 35 maintained by the float valve 30. The invention is robust, in that the grower can adjust for soil condition, time of year, and type of plant by simply adjusting the float valve 30.

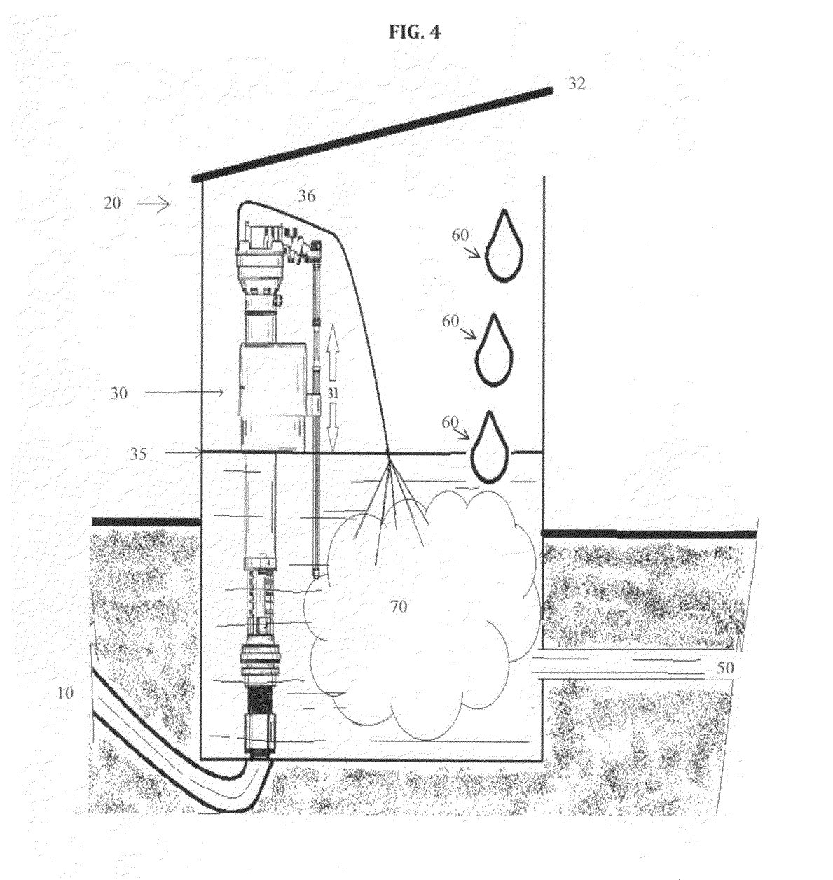

As shown in FIG. 4, the reservoir 20 further acts as a nutrient 60 mixing tank. From above, the lid 32 is opened and water soluble nutrients 60 are added. The introduction of fresh water through the float valve 30 encourages the complete dissolving of solids and absolute mixing of liquids. To further assist with complete intermixing, a mixing hose line 36 may be added to directional focus the stream of incoming water; however, the introduction of fresh water from the water input line 10 creates fluid motion sufficient enough to dissolve and intermix the water soluble nutrients 60. The nutrient rich solution 70 is then fed to the plants with the natural progression of gravity force pushing the nutrient rich solution 70 down the output line and through the holes 55.

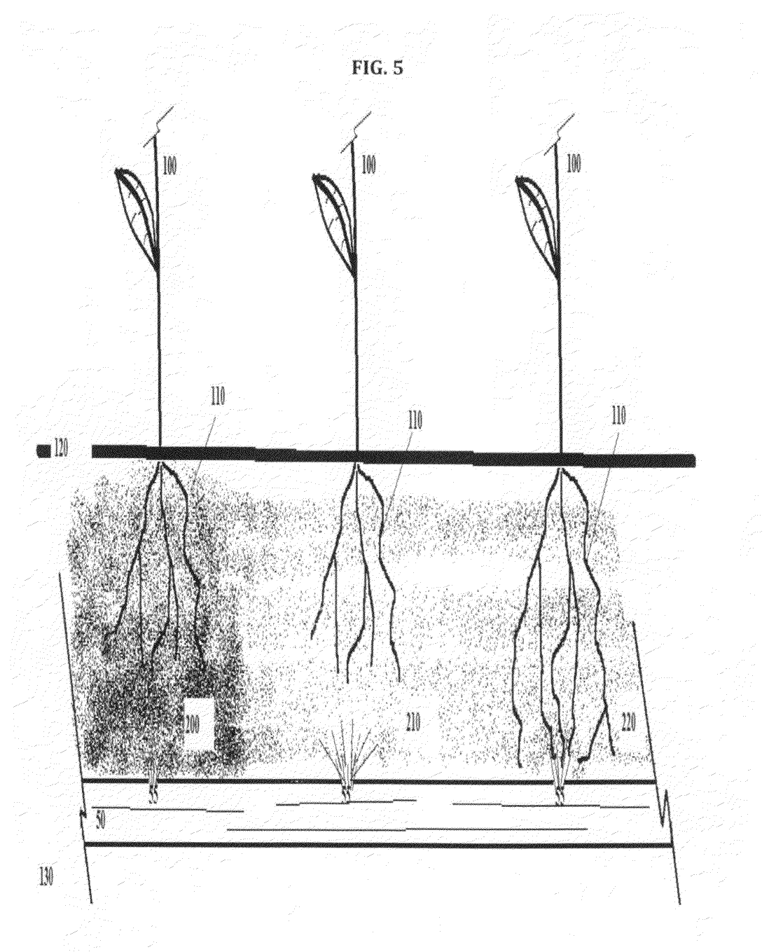

As shown by illustration in FIG. 5, the system is naturally controlled; as the area below the plant saturates when adequately watered, the flow through the hole 55 naturally reduces due to restriction pressures provided by the saturated area. Dry soil readily absorbs more water from the hole 55 than wet to saturated soil. As gravity is the pressure for the output line 50, changes in moisture of the soils around the holes 55 automatically controls the amount of water flowing out.

The system described herein and shown in FIGS. 1-5, works using both gravity and the soil saturation level to accurately and correctly maintain water and nutrient levels at the roots of the plants, without over watering and without polluting the water table with unused nutrient solutions. In short, the ‘weight’ and ‘density’ of the soil controls the fluid as absorbed by the soil. As shown in FIG. 5, depicted as a saturated area 200 provides a wet seal or restriction of fluid flowing out of the output line 50 as through the hole 55. As the soil dries out as shown in dry area 210, the wet seal or restriction is relieved and fluid flows in greater volume that area 200 from the output line 50 into the soil to replenish moisture. Over time, the roots are trained in on that hole 55 in order to maximize efficient uptake of nutrient and water as shown in root trained area 220. Gravity is the natural force that pressures the flow of fluid from the reservoir 20 directly to the plants without wasting elements by broadcasting the same on the surface. When the invention is in use, there is minimal to no loss of nutrients, minimal to no loss of water to evaporation, nor unnecessary attraction of damaging pests.

One of ordinary skill in the art will immediately realize the scalability of a system as described, for backyard application or commercial farming where thousands of plants are watered and fed simultaneously from the reservoir 20 with gravity as the force of pressure. The ease of feeding plants via a conveniently located reservoir 20 allows a broad area of watering and feeding without the need of using tractors or other mechanical irrigation systems, thereby reducing costs, labor, and decreasing the carbon footprint of the farming enterprise.

What is claimed is:

1. A gravity feed subterranean system for watering plants at their roots, comprising:
a vertically disposed reservoir buried at least partially in the ground;
a water input line having positive water pressure connected to a float valve constructed and arranged within said reservoir such that when the liquid in the reservoir reaches a desired level, the float valve stops water flow from the input line;
a buried output line connected to the reservoir below ground level on one end and plugged at the other, such that the water in the reservoir gravity pressurizes and fills the output line; and
at least one hole through the output line.

2. A gravity feed subterranean system for watering plants at their roots, comprising:
a vertically disposed reservoir having a removable top for receiving dissolvable plant nutrients, buried at least partially in the ground;
a water input line having positive water pressure connected to a float valve constructed and arranged within said reservoir such that when the liquid in the reservoir is below the desired level, water sprays in the reservoir whereby nutrients are dissolved into the water until the reservoir reaches a desired liquid level and the float valve stops water flow from the input line;
a buried output line connected to the reservoir on one end and plugged at the other, such that the water standing in the reservoir pressurizes and fills the output line; and
at least one hole through the output line.

3. A gravity feed subterranean system for watering plants at their roots of claims 1 and 2, wherein the output line is a soaker hose.

4. A gravity feed subterranean system for watering plants at their roots of claims 1 and 2, wherein the float valve is the type used in a toilet.
